(19) United States
(12) Patent Application Publication
(10) Pub. No.: US 2021/0356987 A1
(43) Pub. Date: Nov. 18, 2021

(54) Wearable Data Collection Assembly

(71) Applicant: Marijo Zietlow, Wisconsin Dells, WI (US)

(72) Inventor: Marijo Zietlow, Wisconsin Dells, WI (US)

(21) Appl. No.: 15/931,114

(22) Filed: May 13, 2020

(51) Int. Cl. G06F 1/16; G06F 3/16; H04W 4/029; H04W 4/33; H04W 4/14; G06Q 50/12

(52) U.S. Cl. CPC G06F 1/163; G06F 3/167; G06Q 50/12; H04W 4/33; H04W 4/14; H04W 4/029

(57) ABSTRACT

A wearable data collection assembly includes a data storage unit storing data and a plurality of personal electronic devices. Each of the personal electronic devices is carried by employees of a restaurant. A tracking unit is wearable on a waiter in the restaurant and the tracking unit is in electronic communication with the data storage unit. The tracking unit is in electronic communication with a global positioning system (gps) for tracking movement of the waiter when the waiter is wearing the tracking unit. Additionally, the tracking unit is in electronic communication with each of the personal electronic devices thereby facilitating the waiter to speak with any of the employees of the restaurant.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to data collection device and more particularly pertains to a new data collection device for enhancing efficiency of restaurant operation.

### (2) Description of Related Art Including Information Disclosed Under 37 CFR 1.97 and 1.98

The prior art relates to data collection device.

### (h) BRIEF SUMMARY OF THE INVENTION

An embodiment of the disclosure meets the needs presented above by generally comprising a data storage unit storing data and a plurality of personal electronic devices. Each of the personal electronic devices is carried by employees of a restaurant. A tracking unit is wearable on a waiter in the restaurant and the tracking unit is in electronic communication with the data storage unit. The tracking unit is in electronic communication with a global positioning system (gps) for tracking movement of the waiter when the waiter is wearing the tracking unit. Additionally, the tracking unit is in electronic communication with each of the personal electronic devices thereby facilitating the waiter to speak with any of the employees of the restaurant.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a wearable data collection assembly according to an embodiment of the disclosure.

FIG. 2 is a front view of a tracking unit of an embodiment of the disclosure.

FIG. 3 is a schematic view of an embodiment of the disclosure.

### (j) DETAILED DESCRIPTION OF THE INVENTION

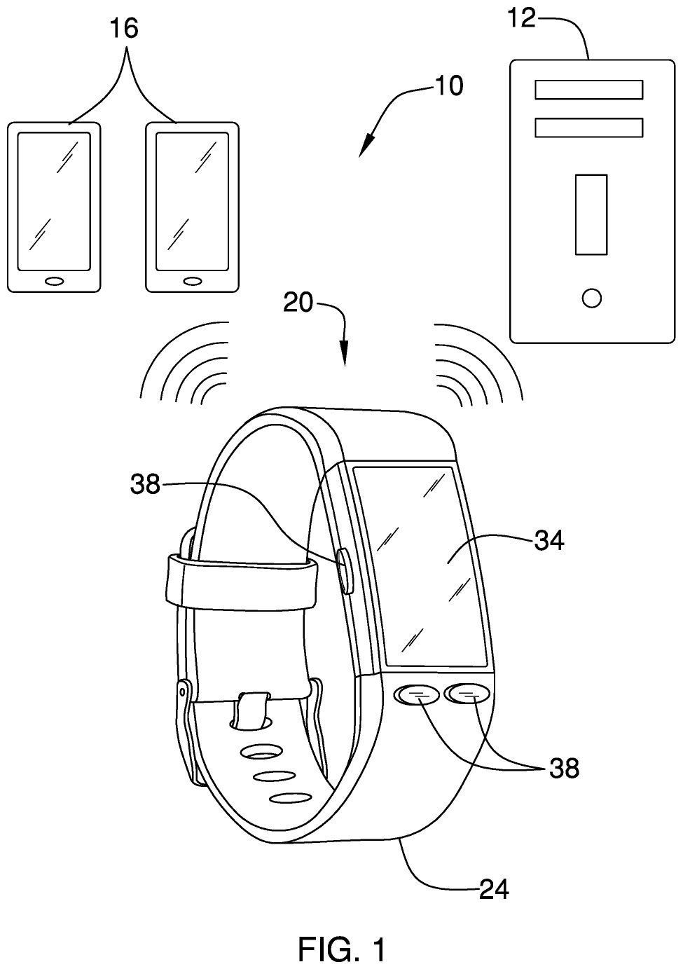

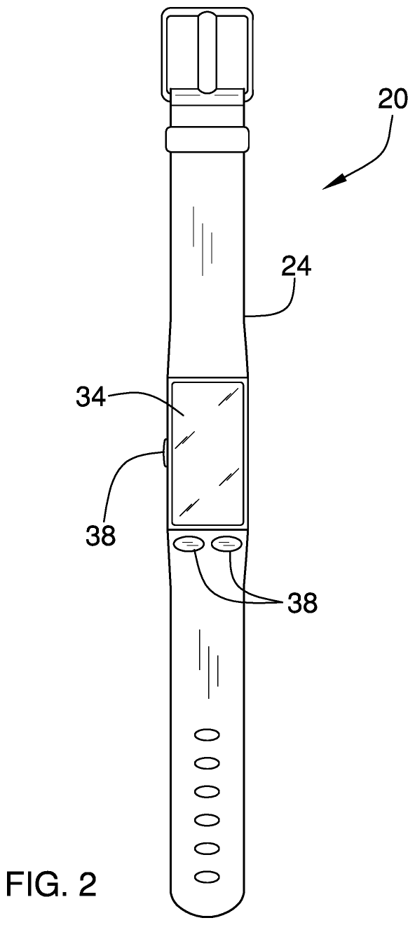

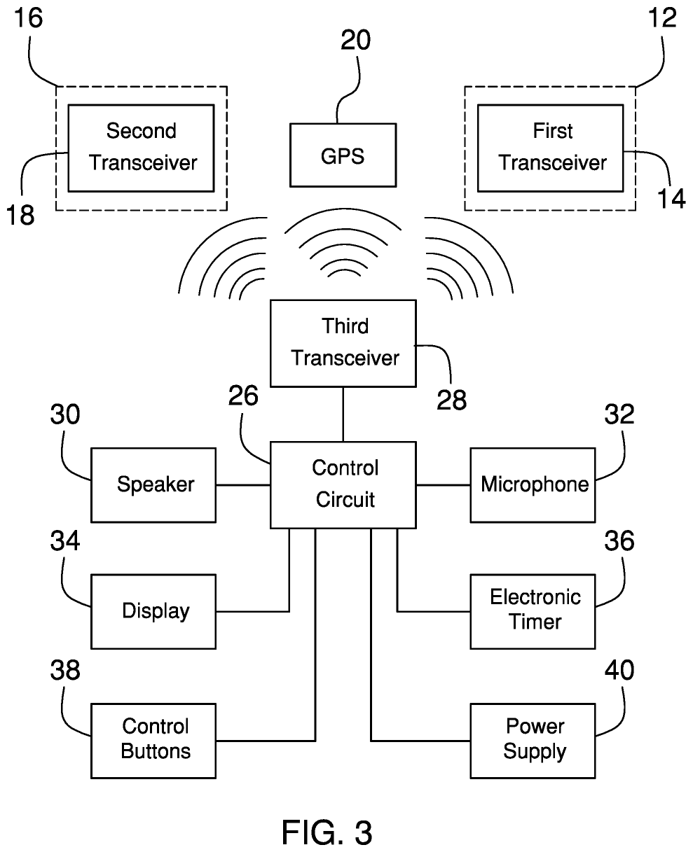

With reference now to the drawings, and in particular to FIGS. 1 through 3 thereof, a new data collection device embodying the principles and concepts of an embodiment of the disclosure and generally designated by the reference numeral 10 will be described.

As best illustrated in FIGS. 1 through 3, the wearable data collection assembly 10 generally comprises a data storage unit 12 that stores data. The data comprise restaurant payroll, restaurant staffing schedules and other data pertaining to the operation of a restaurant. The data storage unit 12 includes a first transceiver 14 and the data storage unit 12 may comprise a personal computer or other electronic data storage device. The data storage unit 12 is positioned in a restaurant that employed waiters, cooks, management and other employees associated with dine-in restaurants. Additionally, the first transceiver 14 may comprise a radio frequency transceiver.

A plurality of personal electronic devices 16 is included and each of the personal electronic devices 16 is carried by employees of the restaurant. Each of the personal electronic devices 16 includes a second transceiver 18. Each of the personal electronic devices 16 may comprise a smart phone, a laptop computer or other similar electronic device. Additionally, the second transceiver 18 may comprise a radio frequency transceiver and the second transceiver 18 may employ Bluetooth communication protocols.

A tracking unit 20 is provided that is wearable on a waiter in the restaurant. The tracking unit 20 is in electronic communication with the data storage unit 12. In this way the tracking unit 20 can track when the waiter clocks in and clocks out with respect to hours worked at the restaurant. Additionally, the tracking unit 20 is in electronic communication with a global positioning system (gps) 22. In this way the tracking unit 20 can track movement of the waiter when the waiter is wearing the tracking unit 20. The tracking unit 20 is in electronic communication with each of the personal electronic devices 16. Thus, the waiter can speak with any of the employees of the restaurant. In this way the tracking unit 20 enhances communication between employees of the restaurant during business hours.

The tracking unit 20 comprises a bracelet 24 that is wearable around the waiter's wrist. The bracelet 24 may include a pair of fasteners, similar to those found on a wrist watch or the like. A control circuit 26 is coupled to the bracelet 24 and a third transceiver 28 is coupled to the bracelet 24. The third transceiver 28 is electrically coupled to the control circuit 26. The third transceiver 28 is in electrical communication with each of the first transceiver 14 and the second transceiver 18. Additionally, the third transceiver 28 is in electrical communication with the gps 22. The third transceiver 28 may comprise a radio frequency transceiver or the like and the third transceiver 28 may employ Bluetooth communication protocols for being synched with the second transceiver 18 in each of the personal electronic devices 16.

A speaker 30 is coupled to the bracelet 24 for emitting audible sounds outwardly therefrom. The speaker 30 is electrically coupled to the control circuit 26 to facilitate each of the employees of the restaurant to be able to speak to the waiter. A microphone 32 is coupled to the bracelet 24 for receiving audible sounds. The microphone 32 is electrically coupled to the control circuit 26 to facilitate the waiter to be able to speak with the employees of the restaurant. In this way two way communications is possible between the waiter and the other restaurant employees at all times.

A display 34 is coupled to the bracelet 24 and the display 34 is electrically coupled to the control circuit 26. The display 34 displays indicia comprising words for communicating a text message received from any of the personal electronic devices 16. The display 34 may comprise a LED or other similar electronic display. An electronic timer 36 is coupled to the bracelet 24 and the electronic timer 36 is electrically coupled to the control circuit 26. The electronic timer 36 keeps track of the duration of time that the user has clocked in for work.

A plurality of control buttons 38 is each movably coupled to the bracelet 24. Each of the control buttons 38 is electrically coupled to the control circuit 26. The control buttons 38 controls operational parameters of the control circuit 26, the third transceiver 28, the microphone 32 and the speaker 30. A power supply 40 is coupled to the bracelet 24, the power supply 40 is electrically coupled to the control circuit 26 and the power supply 40 comprises at least one battery.

In use, the waiter wears the tracking unit 20 once the waiter arrives at the restaurant to begin their shift. The tracking unit 20 continuously monitors the location of the waiter while the waiter is working. Additionally, the data storage unit 12 continuously receives the location data from the tracking unit 20 for subsequent analysis. The waiter can immediately communicate with any of the other employees of the restaurant while the waiter is working. In this way kitchen staff can notify the waiter of any changes to the menu, shortages of food or any other changes that could impact patron's food orders. Additionally, restaurant management can analyze data collected during the waiter's shift for improving efficiency of restaurant operations.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wearable data collection assembly being configured to facilitate constant communication between wait staff and kitchen staff in a restaurant, said assembly comprising:
a data storage unit storing data comprising restaurant payroll, restaurant staffing schedules and other data pertaining to the operation of a restaurant;
a plurality of personal electronic devices, each of said personal electronic devices being carried by employees of the restaurant; and
a tracking unit being wearable on a waiter in the restaurant, said tracking unit being in electronic communication with said data storage unit, said tracking unit being in electronic communication with a global positioning system (gps) for tracking movement of the waiter when the waiter is wearing said tracking unit, said tracking unit being in electronic communication with each of said personal electronic devices thereby facilitating the waiter to speak with any of the employees of the restaurant wherein said tracking unit is configured to enhance communication between employees of the restaurant during business hours.

2. The assembly according to claim 1, wherein:
said data storage unit includes a first transceiver; and
each of said personal electronic devices includes a second transceiver; and
said tracking unit includes a third transceiver, said third transceiver being in electrical communication with each of said first transceiver and said second transceiver, said third transceiver being in electrical communication with the gps.

3. The assembly according to claim 2, wherein said tracking unit comprises:
a bracelet being wearable around the waiter's wrist;
a control circuit being coupled to said bracelet, said third transceiver being electrically coupled to said control circuit.

4. The assembly according to claim 3, wherein said tracking unit includes a speaker being coupled to said bracelet for emitting audible sounds outwardly therefrom, said speaker being electrically coupled to said control circuit wherein said speaker is configured to facilitate each of the employees of the restaurant to be able to speak to the waiter.

5. The assembly according to claim 4, wherein said tracking unit includes a microphone being coupled to said bracelet for receiving audible sounds, said microphone being electrically coupled to said control circuit wherein said microphone is configured to facilitate the waiter to be able to speak with the employees of the restaurant.

6. The assembly according to claim 5, wherein said tracking unit includes a display being coupled to said bracelet, said display being electrically coupled to said control circuit, said display displaying indicia comprising words communicating a text message received from any of said personal electronic devices.

7. The assembly according to claim 6, further comprising a plurality of control buttons, each of said control buttons being movably coupled to said bracelet, each of said control buttons being electrically coupled to said control circuit, said control buttons controlling operational parameters of said control circuit, said third transceiver, said microphone and said speaker.

8. The assembly according to claim 3, further comprising a power supply being coupled to said bracelet, said power supply being electrically coupled to said control circuit, said power supply comprising at least one battery.

9. A wearable data collection assembly being configured to facilitate constant communication between wait staff and kitchen staff in a restaurant, said assembly comprising:
a data storage unit storing data comprising restaurant payroll, restaurant staffing schedules and other data pertaining to the operation of a restaurant, said data storage unit including a first transceiver;
a plurality of personal electronic devices, each of said personal electronic devices being carried by employees of the restaurant, each of said personal electronic devices including a second transceiver; and
a tracking unit being wearable on a waiter in the restaurant, said tracking unit being in electronic communication with said data storage unit, said tracking unit being in electronic communication with a global positioning system (gps) for tracking movement of the waiter when the waiter is wearing said tracking unit, said tracking unit being in electronic communication with each of said personal electronic devices thereby facilitating the waiter to speak with any of the employees of the restaurant wherein said tracking unit is configured to enhance communication between employees of the restaurant during business hours, said tracking unit comprising:
a bracelet being wearable around the waiter's wrist;
a control circuit being coupled to said bracelet;
a third transceiver being coupled to said bracelet, said third transceiver being electrically coupled to said control circuit, said third transceiver being in electrical communication with each of said first transceiver and said second transceiver, said third transceiver being in electrical communication with the gps;
a speaker being coupled to said bracelet for emitting audible sounds outwardly therefrom, said speaker being electrically coupled to said control circuit wherein said speaker is configured to facilitate each of the employees of the restaurant to be able to speak to the waiter;
a microphone being coupled to said bracelet for receiving audible sounds, said microphone being electrically coupled to said control circuit wherein said microphone is configured to facilitate the waiter to be able to speak with the employees of the restaurant;
a display being coupled to said bracelet, said display being electrically coupled to said control circuit, said display displaying indicia comprising words communicating a text message received from any of said personal electronic devices;
a plurality of control buttons, each of said control buttons being movably coupled to said bracelet, each of said control buttons being electrically coupled to said control circuit, said control buttons controlling operational parameters of said control circuit, said third transceiver, said microphone and said speaker; and
a power supply being coupled to said bracelet, said power supply being electrically coupled to said control circuit, said power supply comprising at least one battery.
